(19) United States
(12) Patent Application Publication
(10) Pub. No.: US 2022/0256659 A1
(43) Pub. Date: Aug. 11, 2022

(54) INDUCTION COOKING HOB INCLUDING THREE INDUCTION COILS

(71) Applicant: Electrolux Appliances Aktiebolag, Stockholm (SE)

(72) Inventors: Svend Erik Christiansen, Forli (IT); Filippo Martini, Forli (IT); Massimo Nostro, Forli (IT); Alex Viroli, Forli (IT); Laurent Jeanneteau, Forli (IT); Lee Chappell, Hendersonville, TN (US); Alwin Neukamm, Wilhermsdorf (DE); Christian Boehme, Rothenburg ob der Tauber (DE); Stefan Bayerlein, Feuchtwangen (DE)

(21) Appl. No.: 17/732,394

(22) Filed: Apr. 28, 2022

Related U.S. Application Data
(63) Continuation-in-part of application No. 17/345,418, filed on Jun. 11, 2021.
Application No. 17/345,418 is a division of application No. 14/901,965, filed on Dec. 29, 2015, now Pat. No. 11,064,574.

(30) Foreign Application Priority Data
Sep. 5, 2013 (EP) 13183161.2

(51) Int. Cl. H05B 6/06; H05B 6/12

(52) U.S. Cl. CPC H05B 6/065; H05B 6/1245; Y02B 40/00; H05B 2213/05; H05B 6/1272

(57) ABSTRACT

Systems and methods are provided for an induction cooking hob. The induction cooking hob includes at least three induction coils each comprising a first shape. The induction cooking hob includes a fourth induction coil arranged lateral to the three induction coils. The fourth induction coil includes a second shape. The induction cooking hob includes one or more generators. The induction cooking hob includes a control unit that is configured to control the one or more generators to supply power to the at least three induction coils and the fourth induction coil.

### PRIORITY

This application is a continuation-in-part of U.S. application Ser. No. 17/345,418 filed on Jun. 11, 2021, which is a divisional of U.S. application Ser. No. 14/901,965 (U.S. Pat. No. 11,064,574) filed on Dec. 29, 2015 which is a U.S. National Phase application Serial No. PCT/EP2014/065731, filed on Jul. 22, 2014, which claims the benefit of European application Serial No. 13183161.2, filed on Sep. 5, 2013. These applications are incorporated herein by reference.

### BRIEF SUMMARY

Embodiments of the present disclosure provide an induction cooking hob. The induction cooking hob may include at least three induction coils each comprising a first shape. The induction cooking hob may include a fourth induction coil arranged lateral to the three induction coils. The fourth induction coil may include a second shape. The induction cooking hob may include one or more generators. The induction cooking hob may include a control unit that is configured to control the one or more generators to supply power to the at least three induction coils and the fourth induction coil.

### BRIEF DESCRIPTION OF THE DRAWINGS

FIG. 1 illustrates a schematic circuit diagram of a cooking area for an induction cooking hob according to a preferred embodiment of the present invention.

FIG. 2 illustrates a schematic top view of the induction cooking hob according to the preferred embodiment of the present invention.

FIG. 3 illustrates a further schematic top view of the induction cooking hob according to the preferred embodiment of the present invention.

FIGS. 4A-4C depict an induction cooking hob according to an example embodiment.

FIG. 4D depicts a sensor of the induction cooking hob according to an example embodiment.

FIG. 5 illustrates an induction cooking hob including one or more cooking zones according to an exemplary embodiment.

FIG. 6 illustrates an induction cooking hob including one or more cooking zones according to another exemplary embodiment.

FIG. 7 illustrates an induction cooking hob including one or more cooking zones according to another exemplary embodiment.

FIG. 8A depicts a schematic for a first type of generator according to an exemplary embodiment. FIGS. 8B-8E depict schematics of switching operation of the first type of generator of FIG. 8A according to an exemplary embodiment.

FIG. 9A depicts a schematic for a first type of generator according to an exemplary embodiment.

FIGS. 9B-9E depict schematics of switching operation of the second type of generator of FIG. 9A according to an exemplary embodiment.

FIG. 10 depicts a schematic of air flow according to an exemplary embodiment.

### DETAILED DESCRIPTION

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

The present invention relates to an induction cooking hob including at least one cooking area comprises at least three induction coils. Further, the present invention relates to a method for controlling a cooking area.

On cooking hobs, in particular on induction cooking hobs, there is a present trend that the cooking zones are not arranged in fixed places, but are flexibly put together by one or more heating elements. Cookware may be put onto an arbitrary position of the cooking area by the user. A pot detection device recognizes said position, so that the heating elements below the cookware may be activated.

However, it is difficult to set the appropriate powers for the relevant heating elements. Further, audible interference may be generated, if the difference between the instant powers of adjacent activated induction coils corresponds with differences between frequencies within the range of audible interference.

It is an object of the present invention to provide an improved induction cooking hob with a cooking area and an improved method for controlling the power of the induction coils of the cooking area.

The object of the present invention is achieved by the induction cooking hob according to the claims.

The induction cooking hob according to the present invention includes at least one cooking area, wherein:
the cooking area comprises at least three induction coils,
the induction coils of at least one cooking area are arranged side-by-side,
each induction coil of at least one cooking area has an elongated shape,
the longitudinal axes of the induction coils within one cooking area are arranged in parallel,
each induction coil of the cooking area is associated with a dedicated induction generator,
the induction generators are connected or connectable to at least one current line,
the induction generators are connected to and controlled or controllable by at least one control unit,
requested powers for each used induction generator are adjusted or adjustable independent from each other by a user interface, and
instant powers of the induction generators within a cycle pattern are controlled or controllable independent from each other by the control unit.

The main idea of the present invention is the geometric properties of the cooking area and the induction coils on the one hand and the dedicated induction generator for each induction coil of the cooking area on the other hand. The geometric properties of the cooking area and the induction coils allow a number of arrangements of cookware with different shapes. The dedicated induction generator for each induction coil allows an independent setting of power of each induction coil.

Preferably, the induction coils of at least one cooking area have an oval and/or elliptical shape.

For example, the induction generators are connected or connectable to the same current line.

Alternatively, the induction generators are connected or connectable to at least two different current lines, wherein said current lines have different phases.

Further, the control unit may be provided for performing at least one cooking mode, wherein the activated induction coils work with one single setting of the requested power.

Moreover, the control unit may be provided for performing at least one cooking mode with at least two different settings of requested powers, wherein at least one activated induction coil works with the setting of one requested power and at least one other activated induction coil works with the setting of another requested power.

In particular, the cooking area comprises four induction coils.

Furthermore, the induction cooking hob may comprise a number of pot detection devices, wherein each induction coil is associated to at least one pot detection device.

The object of the present invention is further achieved by the method according to claim 9.

According to the present invention, the method is provided for controlling a cooking area on an induction cooking hob, wherein the cooking area comprises at least three induction coils and said method comprises the steps of:

setting a requested power for each used induction coil by a user interface,

selecting a number of subsequent cycle patterns from a table stored in a memory of a control unit,

defining activated and deactivated induction coils by each selected cycle pattern,

determining a cycle time for each selected cycle pattern and a power balance between the activated induction coils, so that a desired average power for each induction coil is obtained over a period of one or more selected cycle patterns, and

the sum of the instant powers of the activated induction coils within each selected cycle pattern is equal to the sum of the requested powers for each used induction coil.

Preferably, the difference between the instant powers of adjacent activated induction coils is small enough, so that the difference between frequencies associated to the instant powers avoids the generation of audible interference. In particular, the difference between said frequencies is less than 1000 Hz.

Further, the desired average power for each induction coil over the period of one or more selected cycle patterns may be equal to the requested power for said induction coil.

Preferably, as many induction coils as possible are activated within one cycle patterns.

In a similar way, the instant powers of the activated induction coils may be as low as possible.

In particular, variations of the instant powers of the activated induction coils are as low as possible.

At last, the method is provided for the induction cooking hob mentioned above.

Novel and inventive features of the present invention are set forth in the appended claims.

The present invention will be described in further detail with reference to the accompanied drawings, in which

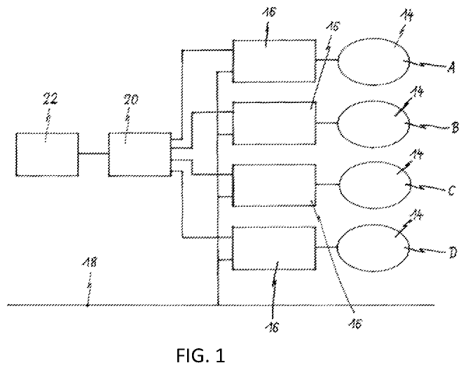

FIG. 1 illustrates a schematic circuit diagram of a cooking area for an induction cooking hob according to a preferred embodiment of the present invention,

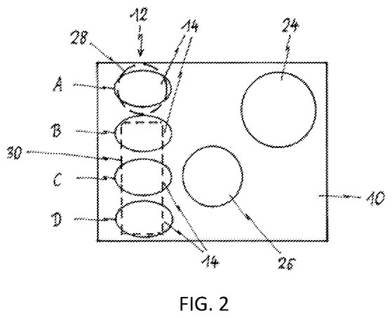

FIG. 2 illustrates a schematic top view of the induction cooking hob according to the preferred embodiment of the present invention, and

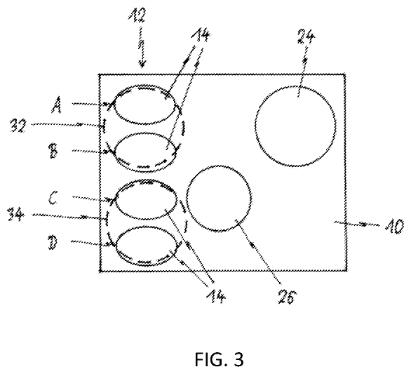

FIG. 3 illustrates a further schematic top view of the induction cooking hob according to the preferred embodiment of the present invention.

FIG. 1 illustrates a schematic circuit diagram of a cooking area 12 for an induction cooking hob 10 according to a preferred embodiment of the present invention.

The cooking area 12 comprises four induction coils 14 arranged side-by side. In this example, the four induction coils 14 form a line. A first, second, third and fourth induction coil 14 is denoted by the letter A, B, C and D, respectively. Further, the cooking area 12 comprises four induction generators 16, a current line 18, a control unit 20 and a user interface 22. The current line 18 is provided for supplying rectified mains voltage. The current line 18 is connected to power input terminals of the four induction generators 16. Each induction generator 16 corresponds with one induction coil 14. An output terminal of each induction generator 16 is connected to the associated induction coil 14. The user interface 22 is connected to an input terminal of the control unit 20. Four output terminals of the control unit 20 are connected to corresponding control input terminals of the induction generators 16. For example, the induction generator 16 is realized by a half-bridge inverter. Each induction coil 14 is associated to at least one pot detection device.

By operating the user interface 22 different cooking modes can be selected by a user. For example, the user interface 22 may comprise dedicated touch keys for said cooking modes. In a preferred embodiment the following four cooking modes are provided. According to a first cooking mode, the four induction coils A, B, C and D work with one single power setting. According to a second cooking mode, the four induction coils A, B, C and D work with two different power settings, wherein the first and second induction coils A and B work with one power setting and the third and fourth induction coils C and D work with another power setting. According to a third cooking mode, the four induction coils A, B, C and D work with two different power settings, wherein the first induction coil A works with one power setting and the second, third and fourth induction coils B, C and D work with another power setting. According to a fourth cooking mode, the four induction coils A, B, C and D work with two different power settings, wherein the first, second and third induction coils A, B and C work with one power setting and the fourth induction coil D works with another power setting. The third and fourth cooking modes are the same in view of a functional aspect.

In the first cooking mode, the induction coils 14 covered by cookware are activated at the same working frequency in order to cancel acoustic interference noise. However, in the second, third and fourth cooking modes, the induction coils 14 are affected by different power settings and therefore by different frequencies, so that acoustic interference noise has to be avoided. The acoustic interference noise occurs, if the frequency difference between adjacent induction coils 14 is within the audible range of the human ear. Since the power is set by the user, the frequency depends on the power setting, so that often the frequency difference may be within the audible range.

In order to avoid the acoustic interference noise, the induction coils 14 are activated and deactivated according to a number of subsequent cycle patterns T1 to T11, in which not all of the induction coils 14 are activated during the same time. The sum of the instant powers iP of the activated induction coils 14 is kept in such a way that the differences of the instant powers iP between the cycle patterns T1 to T11 are small. In general, the variance of the instant powers iP must be small enough in order to comply with existing norms for flickering on the current line 18. The used cycle patterns T1 to T11 are structured in such a way that adjacent activated induction coils 14 have a small or no frequency difference. In contrast, the activated induction coils 14, which are not adjacent, may have different frequencies and powers.

The induction coils 14 activated at a certain time should have a total instant power iP, which is equal to the sum of all requested powers rP. However, a variation of the total instant power iP between the cycle patterns T1 to T11 may be allowed with the scope of the EMC norms.

The following table illustrates the possible combinations of activated and deactivated induction coils A, B, C and D, in which two, three or four of the induction coils A, B, C and D are activated at the same time. The first induction coil A is adjacent to the second induction coil B, in turn the second induction coil B is adjacent to the third induction coil C, and the third induction coil C is adjacent to the fourth induction coil D, as shown in FIG. 1. The second line to the fifth line of said table indicate the activated and deactivated states of the induction coils A, B, C and D, respectively. The eleven different cycle patterns are denoted by T1 to T11 in the first line. The last line of the table indicates the number N of the simultaneously activated induction coils A, B, C and D.

| | T1 | T2 | T3 | T4 | T5 | T6 | T7 | T8 | T9 | T10 | T11 |
|---|---|---|---|---|---|---|---|---|---|---|---|
| A | x | x | x | x | | X | | x | | | x |
| B | x | x | x | | x | | x | x | | X | |
| C | x | x | | x | x | X | | | x | X | |
| D | x | | x | x | x | | x | | x | | x |
| N | 4 | 3 | 3 | 3 | 3 | 2 | 2 | 2 | 2 | 2 | 2 |

A number of the cycle patterns T1 to T11 is selected from the above table. A relative cycle time t for each selected cycle pattern T1 to T11 and a power balance between the induction coils A, B, C and D is set in such a way, that the desired average power for each induction coil A, B, C and D is achieved over one or more cycle patterns T1 to T11. The instant power iP of the individual induction coils A, B, C and D depends on the number of activated induction coils A, B, C and D, the selected power balance and the total requested power rP. It is preferred, that as many induction coils A, B, C and D as possible are activated within the given cycle pattern T1 to T11, so that the variation of the instant powers iP of the induction coils A, B, C and D are minimized, and that the power is uniform.

The following table illustrates the default individual duty settings of the induction coils A, B, C and D for each cycle pattern T1 to T11. The numerical values in the second line to the fifth line of said table indicate the percentages of the power of the induction coils A, B, C and D, respectively. The last line of the table indicates the number N of the simultaneously activated induction coils A, B, C and D.

| | T1 | T2 | T3 | T4 | T5 | T6 | T7 | T8 | T9 | T10 | T11 |
|---|---|---|---|---|---|---|---|---|---|---|---|
| A | 0.25 | 0.33 | 0.33 | 0.33 | | 0.5 | | 0.5 | | | 0.5 |
| B | 0.25 | 0.33 | 0.33 | | 0.33 | | 0.5 | 0.5 | | 0.5 | |
| C | 0.25 | 0.33 | | 0.33 | 0.33 | 0.5 | | | 0.5 | 0.5 | |
| D | 0.25 | | 0.33 | 0.33 | 0.33 | | 0.5 | | 0.5 | | 0.5 |
| N | 4 | 3 | 3 | 3 | 3 | 2 | 2 | 2 | 2 | 2 | 2 |

In particular, the cycle patterns T6, T7 and T11 can be selected as the preferred last cycle patterns, wherein the power balance between two activated induction coils A, B, C and/or D can be adjusted in order to achieve the desired power distributions. The activated induction coils A, B, C and/or D of the cycle patterns T6, T7 and T11 are not adjacent. Thus, the activated induction coils A, B, C and/or D of the cycle patterns T6, T7 and T11 may have arbitrary frequencies without generating acoustic interference noise.

According to a first example, the requested power rP for the first induction coil A is rP=100 W, for the second induction coil B is rP=150 W, for the third induction coil C is rP=350 W, and for the fourth induction coil D is rP=400 W.

In said first example, the method of selecting the cycle patterns and setting the duty are performed as follows. A cycle pattern with three activated induction coils B, C and D is selected, wherein the induction coil A is omitted, which has a requested power rP closest to the difference between the highest and second highest requested power rP. A further cycle pattern is selected with two activated induction coils C and D having the highest and second highest requested power rP until the power is reach for the second highest power. Another cycle pattern is selected with two activated induction coils A and D having the highest requested power iP and the biggest distance from each other. The power balance of the activated induction coils A and D is adjusted in order to reach the requested power rP. Thus, the cycle patterns T5, T9 and T11 are selected.

The relative cycle time t of the cycle pattern T5 is calculated in such a way, that the lowest requested power rP of the activated induction coils B, C or D is reached. This is the requested power rP=150 W for the second induction coil B. Further, the sum of the instant powers iP of the activated induction coils B, C and D is equal to the sum of the requested powers rP for the induction coils A, B, C and D, which is rP=1000 W. The relative cycle time t of the cycle pattern T5 is given by:

t(T5)=iP(B)/(rP(A,B,C,D)/3)=150 W/(1000 W/3)=0.45

The relative cycle time t of the cycle pattern T9 is calculated in such a way, that the instant power iP of the third induction coil C during the cycle pattern T5 is reached. Said instant power iP of the third induction coil C during the cycle pattern T5 is given by:

iP(C;T5)=(rP(A,B,C,D)/3)*t(T5)=(1000 W/3)*0.45=150 W

In the cycle pattern T9 there are two activated induction coils C and D, so that the instant power iP of each activated induction coil C and D is given by:

iP(C)=iP(D)=rP(A,B,C,D)/2=1000 W/2=500 W.

The remaining power of the third induction coil C during the cycle pattern T9 is given by:

iP(C;T9)=rP(C)−iP(C;T5)*t(T5)=200 W

The relative cycle time t of the cycle pattern T9 is given by:

t(T9)=iP(C;T9)/(rP(A,B,C,D)/2)=200 W/(1000 W/2)=0.4

The relative cycle time t of the cycle pattern T11 is given as the remaining time.

t(T11)=1−t(T5)−t(T9)=1−0.45−0.40=0.15

Since the two remaining activated induction coils A and D are not adjacent, the power balance of said two induction coils A and D can be arbitrarily adjusted in order to obtain the desired power for both induction coils A and D. The instant powers iP of the activated induction coil A and D are given by

iP(A;T11)=rP(A)/t(T11)=100 W/0.15=666.7 W

iP(D;T11)=1−iP(A;T11)=333.3 W

The actual power aP of the fourth induction coil can be verified by:

aP(D)=1000 W*(0.45/3+0.4/2)+333.3 W*0.15=400 W

The following table illustrates the relative cycle times t, the instant powers iP, the actual powers aP and the requested powers rP of the cycle patterns T1 to T11 according to the first example.

| | T1 | T2 | T3 | T4 | T5 | T6 | T7 | T8 | T9 | T10 | T11 | aP | rP |
|---|---|---|---|---|---|---|---|---|---|---|---|---|---|
| t | 0 | 0 | 0 | 0 | 0.45 | 0 | 0 | 0 | 0.40 | 0 | 0.15 | | |
| iP(A) | | | | | 0 | | | | 0 | | 666.7 | 100 | 100 |
| iP(B) | | | | | 333 | | | | 0 | | 0 | 150 | 150 |
| iP(C) | | | | | 333 | | | | 500 | | 0 | 350 | 350 |
| iP(D) | | | | | 333 | | | | 500 | | 333.3 | 400 | 400 |
| Sum | | | | | 1000 | | | | 1000 | | 1000 | 1000 | 1000 |

According to a second example, the cooking zones associated to the second, third and fourth induction coils B, C and D are always linked. In the second example, other combinations of cycle patterns are used.

FIG. 2 illustrates a schematic top view of the induction cooking hob 10 according to the preferred embodiment of the present invention. A small cooking vessel 28 and a big cooking vessel 30 are arranged on the induction cooking hob 10. FIG. 2 relates to the second example.

The induction cooking hob 10 comprises a cooking area 12 including the four induction coils 14 arranged in series. Moreover, the induction cooking hob 10 comprises two further induction coils 24 and 26. The four induction coils 14 are elliptical, while the further induction coils 24 and 26 are circular. The longitudinal axes of the four induction coils 14 are arranged in parallel. The small cooking vessel 28 is arranged above the first induction coil A, while the big cooking vessel 30 is arranged above the second, third and fourth induction coils B, C and D. The positions of the small cooking vessel 28 and the big cooking vessel 30 relates to the second example.

The second example differs between two cases. In a first case the power setting of the first induction coil A is lower than the individual requested powers rP of the other induction coils B, C and D, while in a second case the power setting of the first induction coil A is higher than the individual requested powers rP of the other induction coils B, C and D.

In the first case the cycle patterns T1 and T5 are applied. The cycle pattern T1 is applied until the requested power for the first induction coil A is reached, while the cycle pattern T5 is applied during the rest of the time.

The sum of the instant powers iP of all activated induction coils A, B, C and/or D is always equal to the sum of the requested powers rP. In the cycle pattern T1 there are four activated induction coils A, B, C and D, so that the instant powers of each induction coil A, B, C and D is a quarter of the sum of the requested powers. The sum of the requested powers rP is:

rP(A,B,C,D)=100 W+300 W+300 W+300 W=1000 W

The relative cycle time t of the cycle pattern T1 is given by:

t(T1)=iP(A)/(rP(A,B,C,D)/4)=100 W/(1000 W/4)=0.4

The remaining relative cycle time t of the cycle pattern T5 is given by:

t(T5)=1−t(T1)=1−0.4=0.6

The following table illustrates the relative cycle times t, the instant powers iP, the actual power aP and the requested powers rP of the cycle patterns T1 to T11 according to the first case of the second example.

| | T1 | T2 | T3 | T4 | T5 | T6 | T7 | T8 | T9 | T10 | T11 | aP | rP |
|---|---|---|---|---|---|---|---|---|---|---|---|---|---|
| t | 0.4 | 0 | 0 | 0 | 0.6 | 0 | 0 | 0 | 0 | 0 | 0 | 1 | |
| iP(A) | 250 | | | | | | | | | | | 100 | 100 |
| iP(B) | 250 | | | | 333.3 | | | | | | | 300 | 300 |
| iP(C) | 250 | | | | 333.3 | | | | | | | 300 | 300 |
| iP(D) | 250 | | | | 333.3 | | | | | | | 300 | 300 |
| Sum | 1000 | | | | 1000 | | | | | | | 1000 | 1000 |

In the second case the power setting of the first induction coil A is higher than the individual requested powers rP of the other induction coils B, C and D.

In the second case the cycle patterns T2 and T11 are applied. The cycle pattern T2 is applied until the requested powers for the second and third induction coils B and C are reached. In the cycle pattern T11 the instant powers of the first and fourth induction coils A and D are matched in order to obtain the requested powers for said first and fourth induction coils A and D.

The sum of the instant powers iP is always equal to the sum of the requested powers rP. In the cycle pattern T2 there are three activated induction coils A, B and C, so that the instant power of each induction coil A, B and C is a third of the sum of the requested powers. The sum of the requested powers rP is:

rP(A,B,C,D)=300 W+100 W+100 W+100 W=600 W

The instant power iP of each induction coil A, B and C during the cycle pattern T2 is

iP(A)=iP(B)=iP(C)=rP(A,B,C,D)/3=200 W

The relative cycle time t of the cycle pattern T2 is given by:

t(T2)=rP(B)/(rP(A,B,C,D)/3)=100 W/(600 W/3)=0.5

The remaining relative cycle time t of the cycle pattern T11 is given by:

t(T11)=1−t(T2)=1−0.5=0.5

Since the two remaining activated induction coils A and D are not adjacent, the power balance of said two induction coils A and D can be arbitrarily adjusted in order to obtain the desired power for both induction coils A and D.

The instant powers iP of the activated induction coil A and D are given by

iP(D;T11)=rP(D)/t(T11)=100 W/0.5=200 W

iP(A;T11)=rP(A,B,C,D)−iP(D;T11)=600 W−200 W=400 W

The actual power aP of the first induction coil A can be verified by:

aP(A)=(600 W*0.5)/3+(400 W*0.5)=300 W

The following table illustrates the relative cycle times t, the instant powers iP, the actual powers aP and the requested powers rP of the cycle patterns T1 to T11 according to the second case of the second example.

| | T1 | T2 | T3 | T4 | T5 | T6 | T7 | T8 | T9 | T10 | T11 | aP | rP |
|---|---|---|---|---|---|---|---|---|---|---|---|---|---|
| t | 0 | 0.5 | 0 | 0 | 0 | 0 | 0 | 0 | 0 | 0 | 0.5 | 1 | |
| iP(A) | | 200 | | | | | | | | | 400 | 300 | 300 |
| iP(B) | | 200 | | | | | | | | | | 100 | 100 |
| iP(C) | | 200 | | | | | | | | | | 100 | 100 |
| iP(D) | | | | | | | | | | | 200 | 100 | 100 |
| Sum | | 600 | | | | | | | | | 600 | 600 | 600 |

FIG. 3 illustrates a further schematic top view of the induction cooking hob according to the preferred embodiment of the present invention. Two medium cooking vessels 32 and 34 are arranged on the induction cooking hob 10. FIG. 3 relates to an example with two current lines on different phases.

The induction cooking hob 10 comprises the cooking area 12 including the four induction coils 14 arranged in series. Additionally, the induction cooking hob 10 comprises the two further induction coils 24 and 26. The four induction coils 14 are elliptical, while the further induction coils 24 and 26 are circular. The longitudinal axes of the four induction coils 14 are arranged in parallel. A first medium cooking vessel 32 is arranged above the first induction coil A and the second induction coil B, while a second medium cooking vessel 34 is arranged above the third induction coil C and the fourth induction coil D. The first induction coil A and the second induction coil B are supplied by a first current line, while the third induction coil C and the fourth induction coil D are supplied by a second current line, wherein the first and second current lines are on different phases.

In order to avoid the acoustic interference noise, the adjacent induction coils A, B, C and/or D cannot be activated at the same time with a frequency difference within the audible range. The sum of the instant powers iP of the first and second induction coils A and B should be constant. In a similar way, the sum of the instant powers iP of the third and fourth induction coils C and D should also be constant.

The following table illustrates the possible cycle patterns T1 to T3.

| | T1 | T2 | T3 |
|---|---|---|---|
| A | x | x | |
| B | x | | x |
| C | x | x | |
| D | x | | x |

The following table illustrates the relative cycle times t, the instant powers iP, the actual powers aP and the requested powers rP of the cycle patterns T1 to T3 according to an example, in which the first induction coil A and the second induction coil B are supplied by the first current line, while the third induction coil C and the fourth induction coil D are supplied by the second current line, wherein the first and second current lines are on different phases.

| | T1 | T2 | T3 | aP | rP |
|---|---|---|---|---|---|
| t | 0 | 0.5 | 0.5 | | |
| iP(A) | 350 | 980 | 0 | 490 | 500 |
| iP(B) | 350 | 0 | 980 | 490 | 500 |
| iP(C) | 350 | 420 | 0 | 210 | 200 |
| iP(D) | 350 | 0 | 420 | 210 | 200 |
| Sum | 1400 | 1400 | 1400 | | 1400 |

If the sum of the requested powers rP of the first induction coil A and the second induction coil B is equal or about equal to the sum of the requested powers rP of the third induction coil C and the fourth induction coil D, then the cycle pattern T1 is applied the full time. However, if the above requested powers are different, then the cycle patterns T2 and T3 are applied, wherein the relative cycle time t is 0.5 or 50%. The sum of the instant powers iP of the first induction coil A and the second induction coil B is equal to the sum of the corresponding requested powers rP. In a similar way, the sum of the instant powers iP of the third induction coil C and the fourth induction coil D is equal to the sum of the corresponding requested powers rP.

Another application of the present invention is the activation of a further cooking mode, wherein the requested power (rP) changes automatically according to the position of the cooking vessel on the cooking area. The system performs a pot detection on all coils in the cooking area. Depending on which coil or coils) that is (are) covered by the cooking vessel, power is applied to the coil (coils) according to a preset pattern. The requested power (rP) can for instance be low, for example about 400 W, if the cooking vessel is placed on one of the extreme parts of the cooking area. In contrast, the requested power (rP) can be high, for example about 3000 W, if the cooking vessel is placed on the other (opposite) extreme part of the cooking area. At last, the requested power (rP) can have an average value, if the cooking vessel is placed on a central portion of the cooking area, between the extreme parts. A user could be allowed to change the preset pattern from the user interface to obtain the best pattern for the cooking needs at every instance. Applied on the embodiment in FIG. 1, pair of coils could be utilised as the defining regions of preset power, e.g. if a vessel is placed on coils A+B a high power is applied, if placed on coils B+C a medium power I applied and if placed on coils C+D a low power is applied. Naturally, other combinations are possible. If a cooking vessel is moved or removed, a new pot detection can be performed to ensure that only the relevant coil or coils are active.

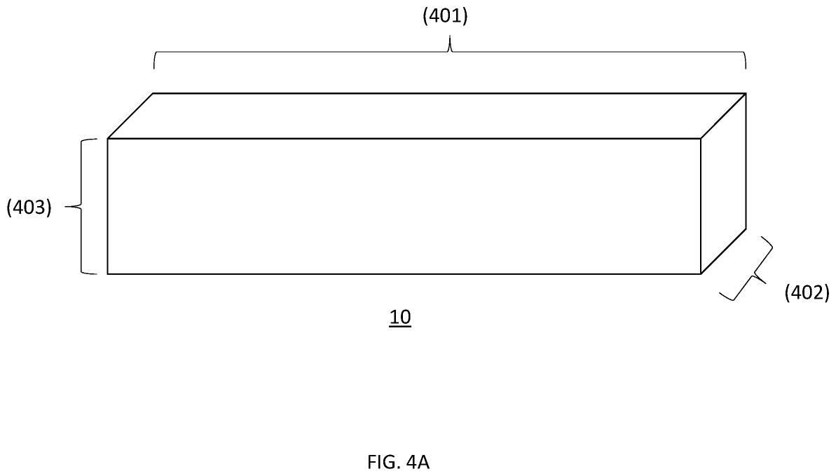

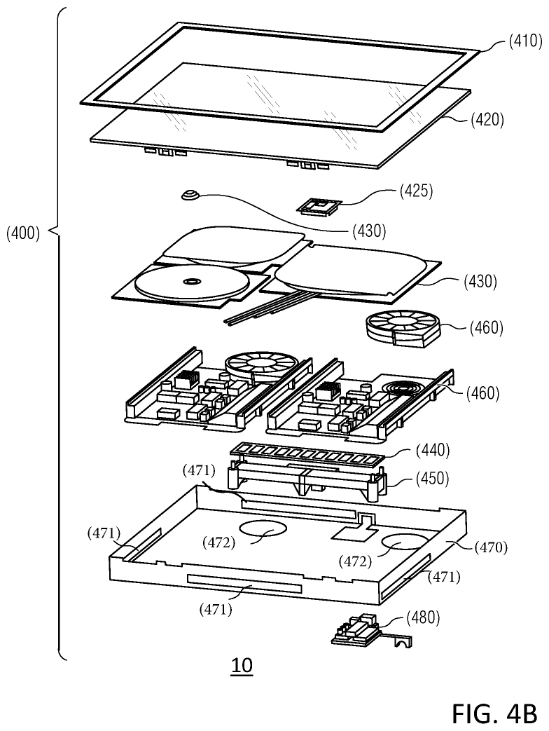

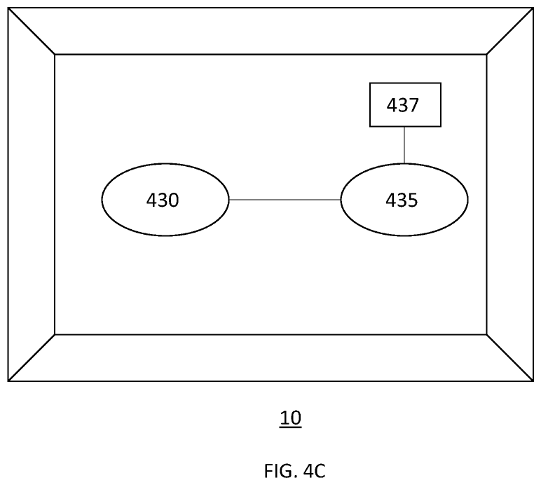

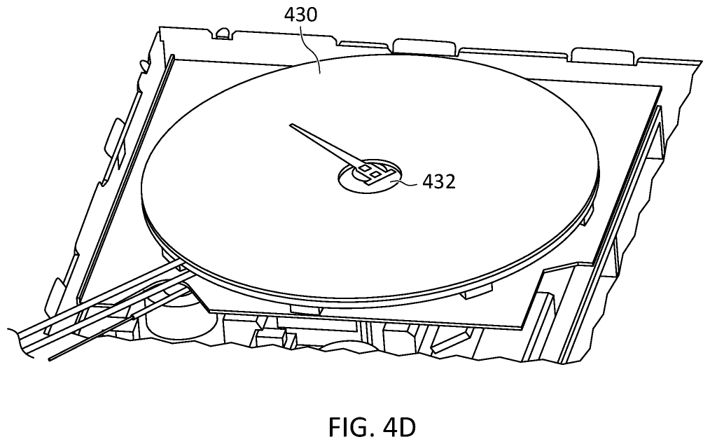

The induction cooking hob, such as the induction cooking hob (10) depicted in FIG. 2 and FIG. 3, may comprise a range of sizes. As illustrated in FIG. 4A according to an exemplary embodiment, the induction cooking hob (10) may be configured to include a plurality of dimensions. Only a portion of the induction cooking hob (10) is illustrated in FIG. 4A. In some examples, the plurality of dimensions may include a first dimension (401), a second dimension (402), a third dimension (403), and so on. The first dimension (401) may include a width. The second dimension (402) may include a depth. The third dimension (403) may include a height. For example, the range of the first dimension (401) may be from 30 cm to 90 cm, the range of the second dimension (402) may be from 30 cm to 90 cm, and the range of the third dimension (403) may be from 30 mm to 60 mm. Without limitation, the induction cooking hob (10) may comprise a surface area ranging from 30 inches to 36 inches. In some examples, the induction cooking hob (10) may comprise a dimension of 60 cm, which may represent the width of the induction cooking hob (10). In some examples, the first dimension (401) may exceed the second dimension (402). In other examples, the second dimension (402) may exceed the first dimension (403). In some examples, the first dimension (401) and the second dimension (402) may be greater than the third dimension (403). For example, the induction cooking hob (10) may be configured as the following dimensions: first dimension (401) of 580 mm width, second dimension (402) of 520 mm depth, and third dimension (403) of 49 mm height.

In addition, the induction cooking hob (10) may comprise a plurality of components (400), as illustrated in FIG. 4B according to an exemplary embodiment. As with FIG. 4A, the induction cooking hob (10) may include the same description and operation of the induction cooking hob (10) as described above with respect to FIG. 2 and FIG. 3. In addition, any number of the components (400) may take on any size and/or shape, including but not limited to circular, rectangular, elliptical, triangular, polygonal, etc. Without limitation, the induction cooking hob (10) may comprise rounded or curved corners, as the hob (10) is not fixed to having a rectangular shape. Furthermore, although the components (400) are configured as sequentially stacked upon each other, it is not limited to this arrangement. In addition, any number of the components (400) may be adhered together so as to allow each component to carry out its respective functionality. In some examples, the first component (410) may comprise a frame. For example, the frame may include material comprising stainless steel. The second component (420) may comprise glass. For example, the glass may include glass ceramic. As further explained below, the induction cooking hob (10) may be configured to include a boil detection module (425) that is disposed at a predetermined surface and/or position of the second component (420). The third component (430) may comprise a plurality of induction coils, such as induction coil (14) depicted in FIG. 1, FIG. 2, and FIG. 3. The plurality of induction coils of the third component (430) may therefore operate in the same manner as described above with respect to induction coil (14) of FIG. 1, FIG. 2, and FIG. 3. In addition, the plurality of induction coils of the third component (430) may include different metal materials and insulation. Without limitation, examples of the various metals and insulation, such as enamel and mica coatings may be included for the induction coils, such as copper or aluminum. In some examples, the induction coils may each comprise a coil sensor including silicone and an electronic component. The fourth component (440) may include a user interface. For example, the user interface of the fourth component (440) may comprise a plurality of components, such as electronic components constituting the user interface. In some examples, the user interface of the fourth component (440) may operate in the same manner as described above with respect to user interface (22) of FIG. 1. The fifth component (450) may comprise a carrier user interface. In some examples, the carrier user interface of the fifth component (450) may include plastic material. The sixth component (460) may comprise a power board. For example, the power board of the sixth component (460) may include an induction power board. The induction power board of the sixth component (460) may include one or more electronic components disposed on a printed circuit board, and plastic components for a housing and a fan. For example, the fan may comprise a board cooling fan of the sixth component (460). The induction power board of the sixth component (460) may be configured to provide power to any number of the induction coils of the third component (430). In some examples, the electronic components of the induction power board of the sixth component (460) may comprise any combination of passive and active components. The seventh component (470) may comprise a box. For example, the box of the seventh component (470) may be configured as a box protection layer that is made of a metal plated sheet metal. By way of example, the box protection layer of the seventh component (470) may include a zinc plated sheet metal. In some examples, the box of the seventh component (470) may be configured to protect the induction power board, including the board cooling fan, of the sixth component (460). For example, the induction power board of the sixth component (460) may be disposed within the box protection of the seventh component (470). In some examples, the induction cooking hob (10) may be configured to provide air circulation such that the air for the induction cooking hob (10) is inputted through one or more ports, such as port (472), and outputted through one or more ports, such as port (471). For example, one or more ports (472) may be located on a different surface of the seventh component (470) than that of the one or more ports (471). In some examples, the one or more ports (472) may be disposed on a bottom surface of the seventh component (470) whereas the one or more ports (471) may be disposed on one or more respective side surfaces of the seventh component (470). The one or more ports (472) may be arranged to each other. The one or more ports (471) may be arranged circumferentially around the one or more ports (472) along the seventh component (470), such as between the seventh component (470) and second component (420) including the glass ceramic. For example, the one or more ports (471) may be configured as one or more air outlets and one or more ports (472) may be configured as one or more air inlets. In other examples, the one or more ports (472) may be configured as one or more air outlets and one or more ports (471) may be configured as one or more air inlets so as to provide the air circulation. Moreover, any of the one or more ports (471) and/or one or more ports (472) may be disposed on other locations other than those illustrated in FIG. 4B. The eighth component (480) may comprise a terminal. For example, the terminal of the eighth component (480) may include a main power terminal with a power cord that may be embedded in plastic as an isolated cable.

The user interface, such as the user interface (22) of FIG. 1 and the user interface of the fourth component (440), may comprise at least one firmware. The user interface may comprise a panel that includes a display screen and a plurality of icons to active one or more features that are responsive to input provided via a touch sensor. In some examples, the user interface may be configured to indicate if any pots are detected as well as any bridging in which a pot may extend across a portion of different cooking zones and/or different induction coils. For example, the user interface may be configured to display pots that are detected by a different color(s). In other examples, the user interface may be configured to display pots that are detected by a darker shade or a lighter shade of a single color. In yet other examples, one or more icons may be configured to display pots that are detected via characters (including but not limited to text, symbols, numbers, etc.) in lieu of, or in addition to, the different or single color. In addition, upon detection of any of the pots, the user interface may be configured to generate and transmit an alert, such as via the panel, indicative of such detection or non-detection. Without limitation, the alert may comprise an audible alert, a visual alert, and/or any combination thereof. In some examples, the alert may be configured to be transmitted at a first time and disabled at the expiration of a second time. The alert may be configured to repeat for a predetermined time period until an icon is activated through touch input or by the system itself.

Additionally, the user interface may include a zone illumination system. For example, the user interface may be configured to indicate positioning of any number of induction coils, such as the induction coils of the third component (430). In addition, illumination from one or more diodes, such as LEDs, may be used to indicate power level and status of functions via one or more icons on the panel of the user interface.

One or more cooking assist components, including but not limited to frying and/or boiling sensors, may be provided and related to automated and/or assisted cooking through the control unit of the induction cooking hob (10). For example, the plurality of induction coils, such as the induction coils of the third component (430), may be coupled to one or more sensors, such as a negative temperature coefficient (NTC) sensor. In some examples, the NTC sensor may be configured to measure temperature and provide an output to a control unit of the induction cooking hob (10). In some examples, the control unit may refer to the control unit (20) as described above with respect to FIG. 1, and may include a processor. Any number of these integrated plurality of induction coils, in which NTC sensors may be attached thereto, may be used for frying to assist with cooking via the induction cooking hob (10) based on the output supplied by the NTC sensor. Accordingly, the induction cooking hob (10) may be configured to operate any number of frying modes to assist with cooking based on the temperature indicated in the NTC sensor output data. In this manner, food items may be fried at an optimized temperature by the relevant induction coil based on the measurement obtained by the NTC sensor. In some examples, the NTC sensor may comprise an aluminum portion that is disposed on the induction coil (430). Referring briefly to FIG. 4D, and by way of example, a NTC sensor (432) is disposed on a center of the induction coil (430). Taken together with the context of FIGS. 4A-4C, it is understood that any number of NTC sensors (432) may be disposed on any surface and/or any position of any number of induction coils (430), and thus the placement of the NTC sensor (432) of the cooking hob (10) is not limited to only being disposed on the center of the induction coil (430).

In addition, the induction cooking hob (10) may be configured to include a boil detection module (425). For example, the boil detection module (425) may be configured to sense boil occurring in any number of pots on the induction cooking hob (10). The boil detection module (425) may be adhered to a component of plurality of components (400), such as at a predetermined surface and/or position of the second component (420) or glass of the induction cooking hob (10). Thus, the placement of the boil detection module (425) of the cooking hob (10) is not restricted to a fixed surface or position of the second component (420). In particular, the boil detection module (425) may be configured to detect vibration of any number of the pots. By way of example, the boil detection module (425) may include a sensor, such as an accelerometer or a strain gauge that is configured to measure and transmit the vibration of a pot. The boil detection module (425) may therefore, just as with the NTC sensor, be configured to assist with cooking. In some examples, the boil detection module (425) may be configured to transmit pot vibration measurement to the control unit of the induction cooking hob (10). In some examples, the control unit may refer to the control unit (20) as described above with respect to FIG. 1. The boil detection module (425) may be connected to the control unit (20) via a communication bus. Accordingly, the induction cooking hob (10) may be configured to operate any number of boil modes to assist with cooking based on the vibration measurement indicated in the boil detection module (425) output data. In this manner, food items may be boiled at an optimized temperature by the relevant induction coil based on the measurement obtained by the boil detection module (425).

FIG. 4C illustrates an induction cooking hob (10) including one or more secondary coils according to an exemplary embodiment. In some examples, the induction cooking hob (10) may refer to the same induction cooking hob (10), such as FIGS. 2, 3, 4A, and 4B. The one or more secondary coils (435) may include winding coils and any number of turns and/or comprise any shape. The one or more secondary coils (435) may serve as receiving coils. As previously explained, the control unit may refer to control unit (20). When the induction coil (430) is activated by the control unit, energy may be transferred from one of the plurality of induction coils, such as plurality of induction coils (430) of FIG. 4B, to a secondary coil (435). In this manner, the induction coil (430) may be configured as a transmitting coil and the secondary coil (435) may be configured as a receiving coil, thereby constituting a transformer, for the magnetic energy to be received from the induction coil (430) to the secondary coil (435) to power up one or more components (437). In some examples, the secondary coil (435) may be the same size and/or shape as the induction coil (430). In other examples, the secondary coil (435) may be a different size and/or shape as the induction coil (430). Without limitation, a distance between the induction coil (430) and the secondary coil (430) may comprise 5 mm to 15 mm, such as 10 mm. In some examples, one or more components (437) may be powered by the one or more secondary coils (435). For example, energy may be transmitted to a secondary coil (435) by the control unit to power any number of components (437) such as sensors, including but not limited to a temperature sensor, such as a thermocouple, resistance temperature detector, thermistor, and semiconductor-based temperature sensor; infrared sensor, such as reflective or transmissive types; pressure sensor; light sensor; smoke sensor; gas sensor; touch sensor; humidity sensor; or the like. Without limitation, applications of any number of other types of components (437) that may be powered based on receipt of energy transmission to a secondary coil (435) may include electronic devices, such as mobile devices, tablets, laptops, computers, personal digital assistants, watches; batteries; power tools; kitchen tools; medical or dental tools; or the like.

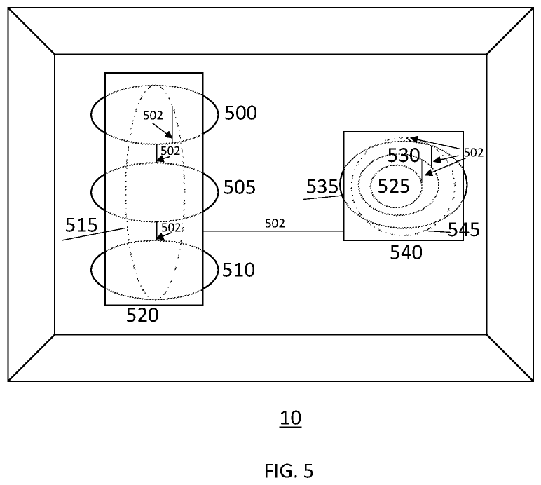

FIG. 5 illustrates an induction cooking hob (10) including one or more cooking zones (520, 540) according to an exemplary embodiment. The one or more cooking zones (520, 540) may comprise extended flex zones. For example, the one or more cooking zones (520, 540) may be formed from at least one array of a plurality of coils that are configured to be controlled by a common control, such as control unit (20), within the induction cooking hob (10). In some examples, the cooking zones (520, 540) formed from the at least one array of the plurality of coils with common control within an induction cooking hob (10) having at least three oval induction coils, and at least one further longitudinal coil arranged lateral thereto where the further laterally arranged coil longitudinal coil extends in the lateral dimension of the cooking zone (52, 540), as explained below. Cooking zone (520) may appear on the opposite side of cooking zone (540), such as the left side of the induction cooking hob (10). In other examples, cooking zone (540) may alternatively appear on the left side of the induction cooking hob (10). Cooking zone (520) may comprise a plurality of coils. For example, the cooking zone (520) of the induction cooking hob (10) may comprise at least three induction coils (500, 505, 510). In some examples, the at least three induction coils (500, 505, 510) may comprise oval induction coils, but are not limited to such a shape. Further, the induction cooking hob (10) may include a longitudinal coil (515) arranged lateral thereto. The longitudinal coil (515) may be configured to extend in the lateral dimension of the cooking zone (520). Further, the longitudinal coil (515) may be configured as a vertical bridge over coils (500, 505, 510) of cooking zone (520). In other examples, the longitudinal coil (515) may be configured as a horizontal bridge over coils (500, 505, 510) of cooking zone (520). In addition, any of the coils (500, 505, 510, 515) may be linked to each other via an actuating element (502). The actuating element (502) may be activated by the control unit (20), such as via user input. In addition, cooking zone (520) may be linked to cooking zone (540) via actuating element (502) so that each cooking zone (520, 540) may be configured to operate at the same frequency by the control unit (20) so as to avoid acoustic noise. In other examples, cooking zone (520) may not be linked to cooking zone (540). In some examples, no actuating elements (502) may be utilized. In other examples, a single actuating element (502) may be utilized. In yet other examples, two or more actuating elements (502) may be utilized. In addition, the actuating element (502) may be placed anywhere on the coil and/or cooking zone.

Cooking zone (540) may be formed from at least one array of a plurality of coils that are configured to be controlled by a common control, such as control unit (20), within the induction cooking hob (10). Cooking zone (540) may comprise a plurality of coils. For example, the cooking zone (540) of the induction cooking hob (10) may comprise at least three induction coils (525, 530, 535). In some examples, the at least three induction coils (525, 530, 535) may comprise oval induction coils, but are not limited to such a shape. Further, the induction cooking hob (10) may include a longitudinal coil (545) arranged lateral thereto. The longitudinal coil (545) may be configured to extend in the lateral dimension of the cooking zone (540). Further, the longitudinal coil (545) may be configured as a vertical bridge over coils (525, 530, 535) of cooking zone (540). In other examples, the longitudinal coil (515) may be configured as a horizontal bridge over coils (525, 530, 535) of cooking zone (540). In addition, any of the coils (525, 530, 535, 545) may be linked to each other via an actuating element (502). The actuating element (502) may be activated by the control unit (20), such as via user input. In addition, cooking zone (540) may be linked to cooking zone (520) via actuating element (502) so that each cooking zone (520, 540) may be configured to operate at the same frequency by the control unit (20) so as to avoid acoustic noise. In other examples, cooking zone (540) may not be linked to cooking zone (520). In some examples, no actuating elements (502) may be utilized. In other examples, a single actuating element (502) may be utilized. In yet other examples, two or more actuating elements (502) may be utilized. In addition, the actuating element (502) may be placed anywhere on the coil and/or cooking zone.

While FIG. 5 illustrates cooking zones (520, 540), it is understood that either zone (520, 540) may be excluded from the induction cooking hob (10). In addition, any of the cooking zones (520, 540) may be duplicated on the induction cooking hob (10) in any pattern and/or size, and thus FIG. 5 is not to be interpreted as being restricted to only the depiction of cooking zones (520, 540). In some examples, any of cooking zones (520, 540) may be configured to extend longitudinally instead of laterally, or inclined or declined with respect to the other cooking zone (520, 540). Thus, cooking zones (520, 540) may each comprise four coils.

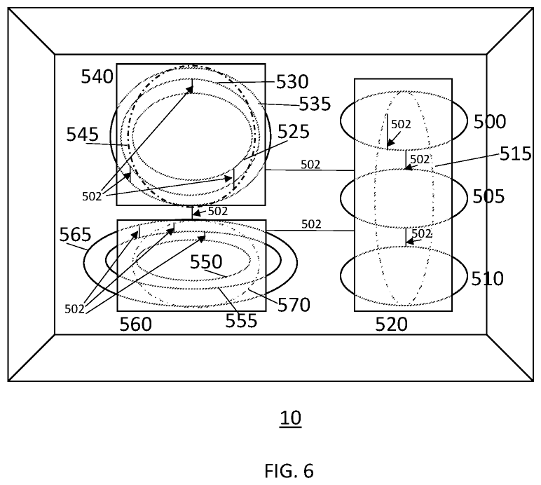

FIG. 6 illustrates an induction cooking hob (10) including one or more cooking zones (520, 540, 560) according to an exemplary embodiment. The one or more cooking zones (520, 540, 560) may be formed from at least one array of a plurality of coils that are configured to be controlled by a common control, such as control unit (20), within the induction cooking hob (10). Cooking zone (520) may appear on the opposite side of cooking zone (540) and cooking zone (560), such as the right side of the induction cooking hob (10). In other examples, cooking zone (540) may alternatively appear on the right side of the cooking zone (560) and cooking zone (520) of induction cooking hob (10). Cooking zone (540) may appear above cooking zone (560). In other examples, cooking zone (560) may appear above cooking zone (540). Cooking zone (520) may comprise a plurality of coils. For example, the cooking zone (520) of the induction cooking hob (10) may comprise at least three induction coils (500, 505, 510). In some examples, the at least three induction coils (500, 505, 510) may comprise oval induction coils, but are not limited to such a shape. Further, the induction cooking hob (10) may include a longitudinal coil (515) arranged lateral thereto. The longitudinal coil (515) may be configured to extend in the lateral dimension of the cooking zone (520). Further, the longitudinal coil (515) may be configured as a vertical bridge over coils (500, 505, 510) of cooking zone (520). In other examples, the longitudinal coil (515) may be configured as a horizontal bridge over coils (500, 505, 510) of cooking zone (520). In addition, any of the coils (500, 505, 510, 515, 525, 530, 535, 545, 550, 555, 565, 570) may be linked to each other via an actuating element (502). The actuating element (502) may be activated by the control unit (20), such as via user input. In addition, cooking zone (520) may be linked to cooking zone (540) and cooking zone (560) via actuating element (502) so that each cooking zone (520, 540, 560) may be configured to operate at the same frequency by the control unit (20) so as to avoid acoustic noise. In other examples, cooking zone (520) may not be linked to cooking zone (540) or cooking zone (560). In some examples, no actuating elements (502) may be utilized. In other examples, a single actuating element (502) may be utilized. In yet other examples, two or more actuating elements (502) may be utilized. In addition, the actuating element (502) may be placed anywhere on the coil and/or cooking zone.

Cooking zone (540) may be formed from at least one array of a plurality of coils that are configured to be controlled by a common control, such as control unit (20), within the induction cooking hob (10). Cooking zone (540) may comprise a plurality of coils. For example, the cooking zone (540) of the induction cooking hob (10) may comprise at least three induction coils (525, 530, 535). In some examples, the at least three induction coils (525, 530, 535) may comprise oval induction coils, but are not limited to such a shape. Further, the induction cooking hob (10) may include a longitudinal coil (545) arranged lateral thereto. The longitudinal coil (545) may be configured to extend in the lateral dimension of the cooking zone (540). Further, the longitudinal coil (545) may be configured as a vertical bridge over coils (525, 530, 535) of cooking zone (540). In other examples, the longitudinal coil (515) may be configured as a horizontal bridge over coils (525, 530, 535) of cooking zone (540). In addition, any of the coils (525, 530, 535, 545) may be linked to each other via an actuating element (502). The actuating element (502) may be activated by the control unit (20), such as via user input. In addition, cooking zone (540) may be linked to cooking zone (520) via actuating element (502) so that each cooking zone (520, 540) may be configured to operate at the same frequency by the control unit (20) so as to avoid acoustic noise. In other examples, cooking zone (540) may not be linked to cooking zone (520). In some examples, no actuating elements (502) may be utilized. In other examples, a single actuating element (502) may be utilized. In yet other examples, two or more actuating elements (502) may be utilized. In addition, the actuating element (502) may be placed anywhere on the coil and/or cooking zone.

Cooking zone (560) may be formed from at least one array of a plurality of coils that are configured to be controlled by a common control, such as control unit (20), within the induction cooking hob (10). Cooking zone (560) may comprise a plurality of coils. For example, the cooking zone (560) of the induction cooking hob (10) may comprise at least three induction coils (550, 555, 565). In some examples, the at least three induction coils (550, 555, 565) may comprise oval induction coils, but are not limited to such a shape. Further, the induction cooking hob (10) may include a longitudinal coil (570) arranged lateral thereto. The longitudinal coil (570) may be configured to extend in the lateral dimension of the cooking zone (540). Further, the longitudinal coil (570) may be configured as a vertical bridge over coils (550, 555, 565) of cooking zone (560). In other examples, the longitudinal coil (570) may be configured as a horizontal bridge over coils (550, 555, 565) of cooking zone (560). In addition, any of the coils (550, 555, 565, 570) may be linked to each other via an actuating element (502). The actuating element (502) may be activated by the control unit (20), such as via user input. In addition, cooking zone (560) may be linked to cooking zone (520) and/or cooking zone (540) via actuating element (502) so that each cooking zone (520, 540) may be configured to operate at the same frequency by the control unit (20) so as to avoid acoustic noise. In other examples, cooking zone (540) may not be linked to cooking zone (520) and/or cooking zone (540). In some examples, no actuating elements (502) may be utilized. In other examples, a single actuating element (502) may be utilized. In yet other examples, two or more actuating elements (502) may be utilized. In addition, the actuating element (502) may be placed anywhere on the coil and/or cooking zone.

While FIG. 6 illustrates cooking zones (520, 540, 560), it is understood that either zone (520, 540, 560) may be excluded from the induction cooking hob (10). In addition, any of the cooking zones (520, 540, 560) may be duplicated on the induction cooking hob (10) in any pattern and/or size, and thus FIG. 6 is not to be interpreted as being restricted to only the depiction of cooking zones (520, 540, 560). In some examples, any of cooking zones (520, 540, 560) may be configured to extend longitudinally instead of laterally, or inclined or declined with respect to the other cooking zone (520, 540, 560). Thus, cooking zones (520, 540, 560) may each comprise four coils.

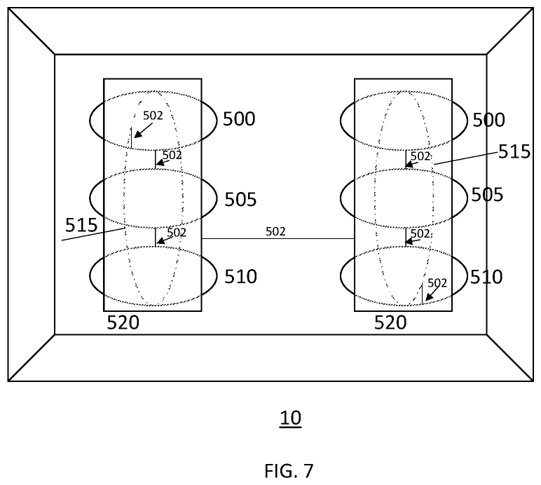

FIG. 7 illustrates an induction cooking hob (10) including one or more cooking zones (520, 540) according to an exemplary embodiment. The one or more cooking zones (520, 540) may be formed from at least one array of a plurality of coils that are configured to be controlled by a common control, such as control unit (20), within the induction cooking hob (10). Cooking zone (520) may appear on the opposite side of cooking zone (540), such as the left side of the induction cooking hob (10). In other examples, cooking zone (540) may alternatively appear on the left side of the induction cooking hob (10). Cooking zone (520) may comprise a plurality of coils. For example, the cooking zone (520) of the induction cooking hob (10) may comprise at least three induction coils (500, 505, 510). In some examples, the at least three induction coils (500, 505, 510) may comprise oval induction coils, but are not limited to such a shape. Further, the induction cooking hob (10) may include a longitudinal coil (515) arranged lateral thereto. The longitudinal coil (515) may be configured to extend in the lateral dimension of the cooking zone (520). Further, the longitudinal coil (515) may be configured as a vertical bridge over coils (500, 505, 510) of cooking zone (520). In other examples, the longitudinal coil (515) may be configured as a horizontal bridge over coils (500, 505, 510) of cooking zone (520). In addition, any of the coils (500, 505, 510, 515) may be linked to each other via an actuating element (502). The actuating element (502) may be activated by the control unit (20), such as via user input. In addition, cooking zone (520) may be linked to cooking zone (540) via actuating element (502) so that each cooking zone (520, 540) may be configured to operate at the same frequency by the control unit (20) so as to avoid acoustic noise. In other examples, cooking zone (520) may not be linked to cooking zone (540). In some examples, no actuating elements (502) may be utilized. In other examples, a single actuating element (502) may be utilized. In yet other examples, two or more actuating elements (502) may be utilized. In addition, the actuating element (502) may be placed anywhere on the coil and/or cooking zone.

Cooking zone (540) may comprise a plurality of coils. For example, the cooking zone (540) of the induction cooking hob (10) may comprise at least three induction coils (500, 505, 510). In some examples, the at least three induction coils (500, 505, 510) may comprise oval induction coils, but are not limited to such a shape. Further, the induction cooking hob (10) may include a longitudinal coil (515) arranged lateral thereto. The longitudinal coil (515) may be configured to extend in the lateral dimension of the cooking zone (540). Further, the longitudinal coil (545) may be configured as a vertical bridge over coils (525, 530, 535) of cooking zone (540). In other examples, the longitudinal coil (515) may be configured as a horizontal bridge over coils (525, 530, 535) of cooking zone (540). In addition, any of the coils (500, 505, 510, 515) may be linked to each other via an actuating element (502). The actuating element (502) may be activated by the control unit (20), such as via user input. In addition, cooking zone (540) may be linked to cooking zone (520) via actuating element (502) so that each cooking zone (520, 540) may be configured to operate at the same frequency by the control unit (20) so as to avoid acoustic noise. In other examples, cooking zone (540) may not be linked to cooking zone (520). In some examples, no actuating elements (502) may be utilized. In other examples, a single actuating element (502) may be utilized. In yet other examples, two or more actuating elements (502) may be utilized. In addition, the actuating element (502) may be placed anywhere on the coil and/or cooking zone.

While FIG. 7 illustrates cooking zones (520, 540), it is understood that either zone (520, 540) may be excluded from the induction cooking hob (10). In addition, any of the cooking zones (520, 540) may be duplicated on the induction cooking hob (10) in any pattern and/or size, and thus FIG. 7 is not to be interpreted as being restricted to only the depiction of cooking zones (520, 540). In some examples, any of cooking zones (520, 540) may be configured to extend longitudinally instead of laterally, or inclined or declined with respect to the other cooking zone (520, 540). Thus, cooking zones (520, 540) may each comprise four coils.

One or more generators may be configured to supply power to one or more induction coils. For example, one or more induction coils may refer to induction coil (14) as described above with respect to FIG. 1, FIG. 2, and FIG. 3. The one or more generators may be controlled by a control unit, such as a control unit (20). High-frequency generation in the power supply of the induction coils may be implemented using any kind of quasi-resonant topology, such as a single semiconductor switch per generator or more than one semiconductor switch arranged in parallel per generator. Rather than utilizing four generators, in which each generator is responsible for providing power to a respective induction coil, a switch may be utilized to facilitate power supply to any number of induction coils. In some examples, the switch may comprise a semiconductor switch, such as an insulated gate bipolar transistor (IGBT). During IGBT switching, a desired amount of current may be turned on or off at a specific voltage in order to activate or deactivate any number of induction coils. In some examples, the semiconductor switch may be arranged in a parallel topology for one or more generators. In this manner, four generators may not be needed to power the each of the induction coils.

In addition, each generator may comprise a high frequency current transformer that is configured to transfer information about the current flowing in a given number of induction coils. The information from the high frequency current transformer may be combined with input voltage and generator drive frequency to obtain an estimate power for any number of cooking zones. The derived estimated power may be used to implement a power control loop based on a comparison with the power requested by input to a user interface.

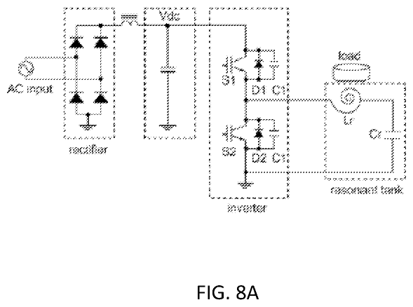

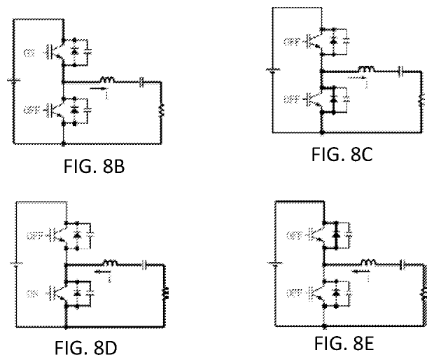

In some applications, a generator may comprise a half-bridge generator, as illustrated in FIG. 8A according to an exemplary embodiment. For a half-bridge generator, two semiconductor switches (S1) and (S2) of an inverter may be utilized in a first power range of 300 to 3600 W. For example, the semiconductor switches of the half-bridge generator may be arranged in a parallel topology. Also included in FIG. 8A is a rectifier, Vdc, a resonant tank, alongside a load. The resonant tank may comprise a resonant circuit including a resonant inductance (Lr) and resonant capacitance (Cr). When (S1) is off, D2 assists (S2) staying on zero voltage or current before being turned on, substantially reducing the loss. The same is the case with (S1). However, some switching loss may result on turn-off. To keep this loss to a minimum, capacitors (C1) and (C2) are connected in parallel to (S1) and (S2) and act as turn-off snubbers that serve to suppress this loss.

FIGS. 8B-8E depict schematics of switching operation of half-bridge of FIG. 8A according to an exemplary embodiment. In FIG. 8B, a first mode of operation is illustrated in which (S1) is on and (S2) is off. In FIG. 8C, a second mode of operation is illustrated in which (S1) is off and (S2) is off. In FIG. 8D, a third mode of operation is illustrated in which (S1) is off and (S2) is on. In FIG. 8E, a fourth mode of operation is illustrated. The IGBTs may be driven with signals 50% duty-cycle and variable frequency >f0.

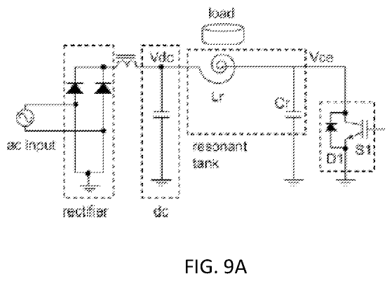

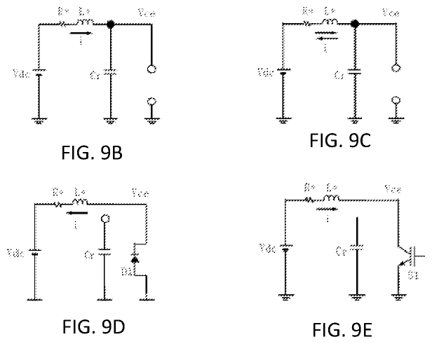

In other examples, a generator may comprise a single switch generator, as illustrated in FIG. 9A according to an exemplary embodiment. For a single switch generator, a single semiconductor switch (S1) may be utilized in a second power range of 800-2000 W. In some examples, the value of the first power range may exceed the value of the second power range. Also included in FIG. 9A is a rectifier, Vdc, resonant tank, alongside a load. By turning on the IGBT while the diode is in a turn-on state, it is possible to turn-on switching with the voltage and current remaining at zero. The resonant tank may comprise a resonant circuit including a resonant inductance (Lr) and resonant capacitance (Cr).

FIGS. 9B-9E depict schematics of switching operation of single switch of FIG. 9A according to an exemplary embodiment. In FIG. 9B, a first mode of operation is illustrated. In FIG. 9C, a second mode of operation is illustrated. In FIG. 9D, a third mode of operation is illustrated. In FIG. 9E, a fourth mode of operation is illustrated. The output power of the inverter may be controlled by a pulse frequency modulation with foxed off time and variable on time.

Without limitation, the application of the half-bridge generator or the single switch generator may thus be dependent on the power range, which in some examples may be dependent on location, such as North America (e.g. for a half-bridge generator) and Asia (e.g. for a single switch generator), but is not limited to such region-specific applications. In some examples, the half-bridge generator (via the two semiconductor switches) may be utilized for activation or deactivation for a single induction coil or two or more induction coils, and the single switch generator (via the single semiconductor switch) may be utilized for activation or deactivation for a single induction coil or two or more induction coils. Any number of half-bridge generators, full bridge generators, and single switch generators may be realized to activate or deactivate any combination of induction coils.

To minimize the number of power devices, power supply to the induction coils may be summed as an input.

In some examples, a multiplexer may be configured to receive a plurality of inputs via a single common output line to supply power, by one or more types of generators using switching technology as described above, to a plurality of induction coils as respective outputs. Without limitation, the switch may comprise an IGBT, a thyristor, or the like. In some examples, the power may be split using any kind of relays, such as mechanical relays, thyristor, etc. For example, a half-bridge generator may be configured to drive alternatively a plurality of coils, including but not limited to two different induction coils, using a switching relay between the half-bridge generator and the plurality of coils. In this manner, a reduced number of generators may be implemented to drive a certain number of coils to optimize power efficiency. In addition, resonant matrix inverter or the like topologies may be configured to supply power to a plurality of outputs, such as coils, minimizing the number of power devices.

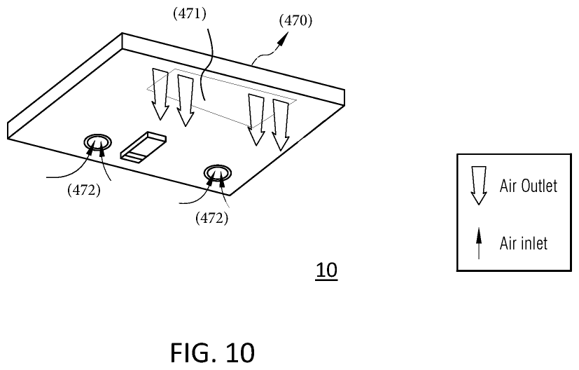

FIG. 10 illustrates an air flow process according to an exemplary embodiment. FIG. 10 may reference or incorporate any component and functionality as previously described above with respect to any of FIGS. 1-9. FIG. 10 illustrates one of the components of the hob, such as one of the components (470) of the induction cooking hob (10). While only single instances of the elements of the component (470) are illustrated, it is understood that the component (470) may include any number of ports (471) and ports (472).

For example, the component (470) of the induction cooking hob (10) may refer to the seventh component (470) of the induction cooking hob (10). In some examples, the seventh component (470) may comprise a box. For example, the box of the seventh component (470) may be configured as a box protection layer that is made of a metal plated sheet metal. By way of example, the box protection layer of the seventh component (470) may include a zinc plated sheet metal. The induction cooking hob (10) may be configured for air circulation such that the air for the induction cooking hob (10) is inputted from the underside thereof through one or more ports, such as port (472), and outputted through one or more ports, such as port (471), that may also be located on the bottom surface of the induction cooking hob (10). In this manner, one or more ports (471) may be configured as one or more air outlets and one or more ports (472) may be configured as one or more air inlets. However, it is understood that the arrows indicative of air outlet and air inlet are non-limiting and are for illustrative purposes and thus are not interpreted to be constrained to such air flow. In other examples, the air may be inputted through one or more ports (471) and outputted through one or more ports (472), such that one or more ports (472) may be configured as one or more air outlets and one or more ports (471) may be configured as one or more air inlets. Moreover, any of the one or more ports (471) and/or one or more ports (472) may be disposed on other locations other than those illustrated in FIG. 10.

### LIST OF REFERENCE NUMERALS

10 induction cooking hob
12 cooking area
14 induction coil
16 induction generator
18 current line
20 control unit
22 user interface
24 further induction coil
26 further induction coil
28 small cooking vessel
30 big cooking vessel
32 medium cooking vessel
34 medium cooking vessel
A first induction coil
B second induction coil
C third induction coil
D fourth induction coil
N number of activated inductions coils
Tn cycle pattern
t relative cycle time
iP instant power
aP actual power
rP requested power

What is claimed is:

1. An induction cooking hob comprising:
at least three induction coils each comprising a first shape;
a fourth induction coil arranged lateral to the three induction coils, the fourth induction coil comprising a second shape;
one or more generators; and
a control unit that is configured to control the one or more generators to supply power to the at least three induction coils and the fourth induction coil.

2. The induction cooking hob of claim 1, further comprising a plurality of components.

3. The induction cooking hob of claim 1, wherein the one or more generators comprises a half-bridge.

4. The induction cooking hob of claim 3, wherein the half-bridge comprises two semiconductor switches.

5. The induction cooking hob of claim 1, wherein the one or more generators comprises a single switch.

6. The induction cooking hob of claim 1, wherein the single switch comprises a IGBT switch.

7. The induction cooking hob of claim 1, further comprising one or more sensors coupled to the at least three induction coils and the fourth induction coil.

8. The induction cooking hob of claim 1, further comprising a boil detection module configured to detect boiling in any number of pots.

9. The induction cooking hob of claim 1, further comprising a user interface including a panel that includes:
a display screen; and
a plurality of icons to active one or more features that are responsive to input provided via a touch sensor.

10. The induction cooking hob of claim 9, wherein the user interface further includes a zone illumination system configured to indicate power level and status of functions via one or more icons on the panel.

11. The induction cooking hob of claim 1, wherein the at least three induction coils and the fourth induction coil are associated with a single cooking zone.

12. The induction cooking hob of claim 1, wherein the at least three induction coils and the fourth induction coil are associated with a first cooking zone that appears adjacent to one or more additional cooking zones.

13. The induction cooking hob of claim 12, wherein the first cooking zone extends in a lateral direction.

14. The induction cooking hob of claim 1, wherein a first generator is configured to operate in a first power range and a second generator is configured to operate in a second power range.

15. The induction cooking hob of claim 7, wherein the control unit is configured to operate a plurality of frying modes based on output received from the one or more sensors.

16. The induction cooking hob of claim 8, wherein the control unit is configured to operate a plurality of boil modes based on output received from the boil detection module.

17. The induction cooking hob of claim 2, wherein at least one component includes an induction power board comprising one or more passive components and one or more active components.

18. The induction cooking hob of claim 9, wherein the user interface is configured to indicate positioning of any number of the at least three induction coils and the fourth induction coil.

19. The induction cooking hob of claim 1, wherein the control unit is configured to transmit energy to a secondary coil so as to provide power to one or more devices.

20. The induction cooking hob of claim 1, wherein at least one generator comprises a high frequency current transformer that is configured to transfer information about current flowing in the at least three induction coils and the fourth induction coil.
